(19) United States
(12) Patent Application Publication
(10) Pub. No.: US 2004/0211218 A1
(43) Pub. Date: Oct. 28, 2004

(54) Method and apparatus for cutting a glass sheet and method for manufacturing a PDP

(75) Inventor: Akira Jotaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/829,155

(22) Filed: Apr. 22, 2004

(30) Foreign Application Priority Data
Apr. 24, 2003 (JP) 2003-120420

(51) Int. Cl. C03B 21/00; C03B 23/00

(52) U.S. Cl. 65/105; 83/169; 65/166; 216/108

(57) ABSTRACT

A linear groove is formed in a glass sheet along a programmed cut line that is set for the glass sheet, and pressure is applied locally to an end of the groove. The pressure is not applied equally uniformly to the whole groove but applied locally to the end of the groove, where an initial crack is induced by the pressure applied thereto. The initial crack is guided by the groove so that the cracking force is propagated inductively along the groove. Distribution of stress in the glass corresponding to the cracking force thus propagated is concentrated locally to a face intersecting orthogonally to the surface of the glass sheet. The face to which the stress is concentrated intersects substantially orthogonally with the surface of the glass sheet. The glass sheet manufactured in this manner can be utilized effectively as a material of a PDP.

### BACKGROUND OF THE INVENTION

1. Field of the Invention

The present invention relates to a method and an apparatus for cutting a glass sheet and a method for manufacturing a PDP (plasma display panel), and particularly relates to a method and an apparatus for cutting a glass sheet for obtaining a plurality of glass sheets for the PDP from a single large-size glass sheet, as well as to a method for manufacturing the PDP.

2. Description of the Related Art

A glass substrate is used for forming a display screen of a plasma display. Glass substrates of a size corresponding to the PDP screen size can be obtained by dividing a large-size glass sheet into several pieces. A glass sheet cutting apparatus is used for dividing the glass sheet. The glass sheet cutting apparatus comprises a heating device and a cooling device and is constructed such that thermal stress is applied to a sheet glass along a programmed cutting line of the sheet glass to thereby induce a crack in the sheet glass, and the glass sheet is cut along the programmed cutting line along with the progress of the crack. This technique is disclosed in Japanese Patent Laid-Open Publication No. 2000-281375, for example.

A sheet glass cannot be cut only by a crack induced by thermal stress, since the progress of the crack will stop in the vicinity of the edges of the sheet glass. According to the prior art, the edge of the sheet glass where the progress of the crack has stopped is pressed and held by a suitable presser so that the external pressing force is applied to the sheet glass to cut the same finally.

However, when the sheet glass is cut by imparting the external pressing force to the sheet glass as is done in the prior art, the sheet will be cut in the warped or deflected state. As the result, the cut surface will be formed obliquely and it is difficult to form the cut surface vertically to the surfaces of the glass substrate. Also, the cut line thus formed will not be straight and it is difficult to form the cut line in a straight line.

A glass substrate constituting a display is required to have a cut surface vertical to the surfaces of the substrate and, also, the cut line is required to be a single straight line or a single flat plane. With the conventional cutting method, however, these requirements cannot be satisfied.

### SUMMARY OF THE INVENTION

An object of the present invention therefore is to provide a method and an apparatus for cutting a glass sheet or PDP substrate having a cut surface vertical to the substrate surfaces, as well as a method for manufacturing a PDP.

Another object of the invention is to provide a method and an apparatus for cutting a glass sheet or PDP substrate having a cut line formed in a straight line, as well as a method for manufacturing a PDP.

Followings are the features of the present invention. In the following description, for a better understanding of the invention, the constituent elements are given respective reference numerals of the attached drawings showing an embodiment of the present invention.

A method for cutting a glass sheet of the present invention comprises the steps of forming a linear groove (5) in a glass sheet (3) along a programmed cutting line (4) that is set for the glass sheet, and applying local pressure to an end of the groove. According to the invention, not the entire groove (5) is uniformly subjected to equal pressure. Instead, only the end of the groove (5) is subjected to local pressure so that an initial crack is induced at the end by the pressure applied thereto. Starting from this initial crack, the cracking force is guided by the groove (5) and inductively propagated along the groove (5). Distribution of the stress inside the glass corresponding to the cracking force propagated in this manner is concentrated locally at the plane that includes the groove (5) and is orthogonal to the surface of the glass sheet 3. The plane to which the stress is concentrated in this manner corresponds to the cut surface due to the physical properties of amorphous glass. The cut surface is substantially orthogonal to the surfaces of the glass sheet. Even if the glass sheet is deflected during a cutting process, it will not affect adversely to the optimization of the cross section of the glass substrate to be cut.

It is preferable that the step of applying local pressure as described above further comprises the step of making a crack along the groove (5) in terms of ensuring the initial induction of stress.

A method for cutting a glass sheet of the present invention comprises the steps of forming a linear groove (5) in a glass sheet (3) along a programmed cutting line that is set for the glass sheet 3, and arranging an elastic plate 20 at an end of the groove (5) for dissipating pressure and arranging a pressure absorber (15) on the rear surface of the glass sheet (3) opposing the end of the cutting line. When pressure is applied to the glass sheet (3) for cutting the same, the absorber (15) helps the dissipation of the pressure to allow the pressure to be dissipated equally along the cutting line, and to promote the concentration of stress of cutting.

The cutting method of the invention further and effectively comprises an additional step of lifting one of two sections of the glass sheet divided by the groove (5) with respect to the other one to from a V-shape section together, by using the groove (5) as the fulcrum. Since the groove (5) constitutes the junction of the two sections, the stress is concentrated on the groove. This method of bending the glass sheet into a V-shape section by the rotational displacement is adopted following the age-old technique used by glass craftsmen. According to the invention, however, the cutting operation is enabled to be automated and mechanized by locally pressing the programmed cutting line during the bending.

The glass sheet cutting method of the present invention is particularly effective for manufacturing a constituent element of a plasma display panel. In this case, the glass sheet (3) is used as a front substrate (33) or a rear substrate (38) of a plasma display panel.

A method for manufacturing a PDP device comprises a first process of producing a plasma display panel 30, a second process of incorporating the plasma display panel 30 into a module (69) together with a circuit for driving the plasma display panel (30), and a third process of electrically connecting an interface (72) to the module (69), the interface (72) for transmitting an image signal after converting the format thereof to the module (69). In the first process, the method for producing the plasma display panel as described above is performed. By modularizing the PDP device components in this manner, the assembly and repair of the device can be simplified.

An apparatus for cutting a PDP substrate according to the present invention comprises an elastic plate (20) arranged at an end of a programmed cutting line (4) of a glass sheet (3) for dissipating pressure, a pressure absorber (15) arranged on the rear surface of the glass sheet (3) opposing the end of the cutting line, and a pressurizing mechanism (12) for applying pressure to the elastic plate (20). The elastic plate (20) may be formed effectively as a face plate to be in surface contact with the surface of the glass sheet (3). In this case, the face plate may be formed of a silicon rubber plate. The pressurizing mechanism makes a crack along and over the programmed cutting line (4). A locally pressing sharp blade (12) is specifically used as a member of the pressurizing mechanism for locally pressing the plate from over the programmed cutting line (4).

It will be effective to add a driving mechanism (19) for lifting one of two sections of the glass sheet (3) to be separated from each other by the programmed cutting line (4), with respect to the other one so as to form a V-shape section. By lifting one of the sections into a V-shape while locally pressing the end of the programmed cutting line (4), it is ensured that the glass sheet (3) is cut reliably along the programmed cutting line (4). By providing the pressurizing mechanism with a pressurizing needle (12) for transferring pressure to the glass sheet (3), it is ensured that stress is concentrated on the region of the cutting line.

The tip end (13) of the pressurizing needle (12) is pointed to the programmed cutting line (4) and is formed sharp so that local stress is concentrated on the linear region of the programmed cutting line (4). It is particularly effective that the pressurizing needle (12) applies pressure to the linear region of the glass sheet (3) through the elastic plate (20) in terms of realizing both dissipation of pressure and local concentration of stress. The tip end (13) may be sharp taking the form of a point, a line, or a semispherical surface, or a semicylindrical surface.

The pressurizing mechanism for applying cutting induction force to a programmed cutting line (4) set for a glass sheet (3) is formed by an applying member (12) mounted on the side of a first surface P1 of the glass sheet (3) for applying cutting induction force to the glass sheet (3) from the side of the first surface P1 and a support (15) arranged on the side of a second surface P2 of the glass sheet (3) in opposition to the applying member (12) for elastically supporting the glass sheet (3) from the side of the second surface P2. Cutting force is imparted to the glass sheet (3) by the local pressure applied by the applying member (12) while dissipating the pressure on the side of the second surface P2, so that the glass sheet (3) can be cut straight along the programmed cutting line while preventing the glass sheet (3) from being broken.

The support is formed of an elastic displacement member (15) directly joined to the second surface P2 and a rigid body (14) supporting the elastic displacement member (15). The elastic support (15) is preferably formed from silicon rubber. The tip end (13) of the applying member (12) is effectively formed sharp to take a form of a point, a line, a semispherical surface, or a semicylindrical surface.

The pressurizing mechanism is formed by a first suction member (25) attached to the second surface P2 side of one of the sections of the glass sheet (14) to be divided by the programmed cutting line (4) so as to adhere by suction to the second surface P2, a second suction member (23) attached to the second surface P2 side of the other section of the glass sheet (3) to be divided by the programmed cutting line (4) so as to adhere by suction to the second surface P2, and a driver (19) for displacing the second suction member (23) to the direction of the first surface P1 with respect to the first suction member (25). The first and second suction members (25, 23) make it possible to cut the glass sheet (3) stably along the programmed cutting line (4) while bending the glass sheet (3). This method of bending the glass sheet into a V-shape for imparting bending stress thereto adopts traditional techniques practiced by glass craftsmen from long ago.

The cutting apparatus may additionally comprise a streak marking unit (2) for marking a streak along the programmed cutting line (4). The applying member (12) makes a crack at an end of the streak (5) and the first and second suction members (25, 23) provide final cutting force for cutting the entire of the glass sheet (3).

### BRIEF DESCRIPTION OF THE DRAWINGS

FIG. 1 is a front view showing a part of an apparatus for cutting a PDP substrate according to an embodiment of the present invention;

FIG. 2 is a front view showing another part of the apparatus for cutting a PDP substrate according to an embodiment of the present invention;

FIG. 3 is a front view showing still another part of an apparatus for cutting a PDP substrate according to an embodiment of the present invention;

FIG. 4 is plan view showing the cutting position of a glass sheet;

FIG. 5 is a plan view showing a position for marking a streak on a glass sheet;

FIG. 6 is a plan view showing the cutting position of a glass sheet;

FIG. 7 is a perspective view showing a PDP; and

FIG. 8 is a circuit diagram showing the modularization of the PDP.

### DETAILED DESCRIPTION OF THE PREFERRED EMBODIMENT

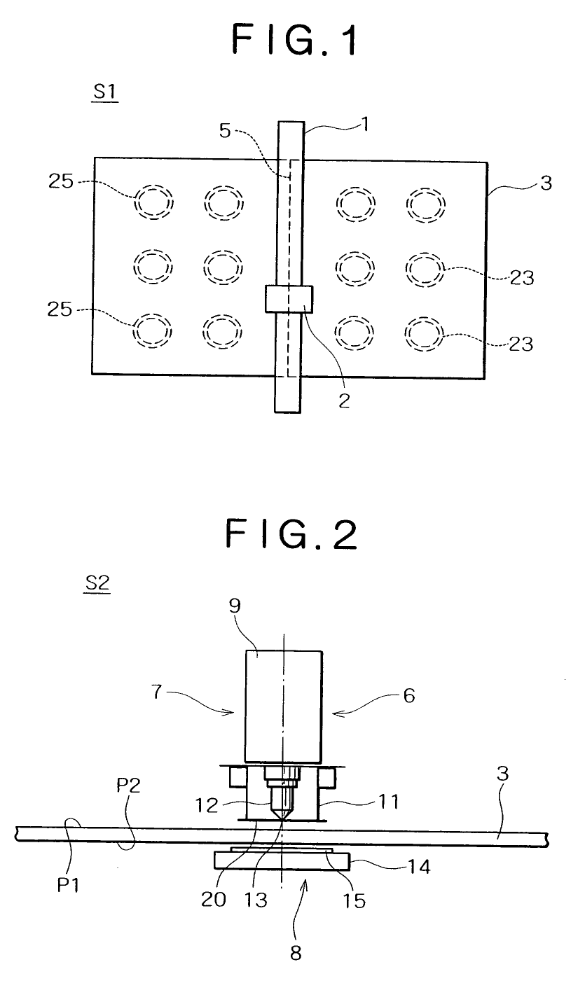

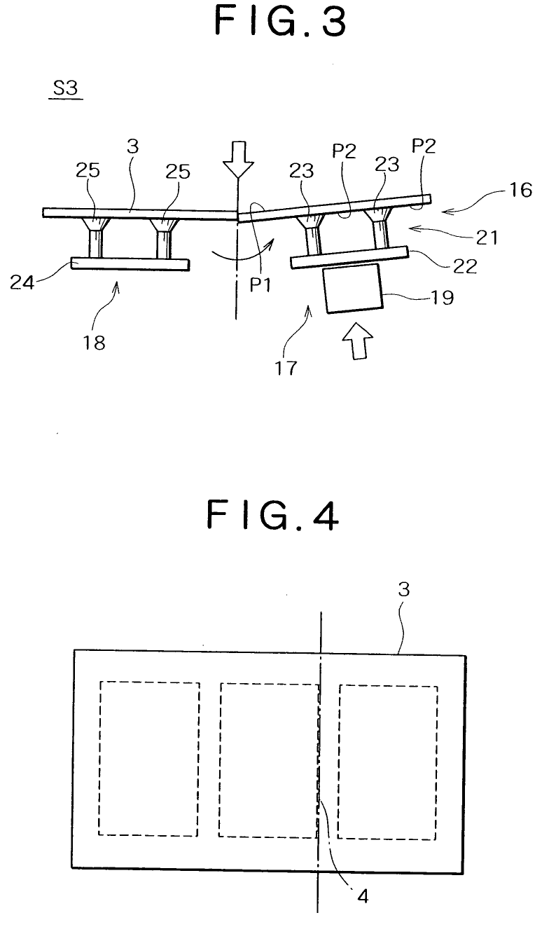

Preferred embodiments of the present invention will be described specifically with reference to the attached drawings. An apparatus for cutting a glass sheet, particularly an apparatus for cutting a PDP substrate according to the invention comprises a streak marking process, a crack making process, and a cutting process. The streak marking process S1 is shown in FIG. 1, the crack making process S2 is shown in FIG. 2, and the cutting process S3 is shown in FIG. 3.

In the streak marking process S1 as shown in FIG. 1, a suction unit 1 and a streak marking unit 2 are used. The suction unit 1 extends long along a programmed cutting line of a glass substrate 3 and adheres by suction to a first surface P1 of the glass substrate 3 to hold the glass substrate 3 by suction. As shown in FIG. 4, a programmed cutting line 4 is set virtually in the suction unit 1. The streak marking unit 2 is capable of marking a straight cut guiding streak (or groove) 5 corresponding with the programmed cutting line 4 that is assumingly drawn on one surface of the glass substrate 3. The streak marking unit 2 is provide with a moving mechanism (not shown) for moving a diamond cutter along the programmed cutting line 4. The diamond cutter may be substituted by a nozzle for blowing a harsh jet of steel sand against the glass surface.

In the crack making process S2, a pressurizing mechanism 6 is used as shown in FIG. 2. The pressurizing mechanism 6 comprises a pressurizer 7 and a pressure receiver 8. The pressurizer 7 is constituted by an air cylinder 9, an abutting unit 11 supported by the air cylinder 9 and abutting against the first surface of the glass sheet 3, and a locally pressing sharp blade 12 constructed to move toward the glass sheet 3 by receiving thrust from the air cylinder 9 and accommodated inside the abutting unit 11. The locally pressing sharp blade 12 is formed of a thin stainless plate. The stainless plate is formed from stainless steel. When the air cylinder 9 moves towards the glass sheet 3, the abutting unit 11 comes into contact with the glass sheet 3 elastically and not with impact. The abutting unit 11 is formed as a cylindrical body of rubber itself. Alternatively, it is constructed so as to receive biasing force from a coil spring and be thereby pushed out with the advancing position restricted by the coil spring. The abutting unit 11 is formed in the shape of a closed-end cylinder, the bottom of which is effectively formed as an upper elastic plate (e.g. silicon plate) 20 that is brought into surface contact with and joined with the surface of the glass sheet 3.

The thickness of the stainless plate is preferably in the range of 0.3 mm to 0.5 mm. The tip end (lower end) of the stainless plate is formed into a sharp point or a sharp line 13. This sharp point or sharp line is preferably formed in a rounded (semispherical or semicylindrical) shape. The pressure receiver 8 comprises a backing plate 14 and a lower elastic plate (pressure dissipating plate) 15. The lower elastic plate 15 is arranged between the backing plate 14 and the second surface P2 of the glass substrate 3. The pressurizer 7 and the pressure receiver 8 are arranged on the opposite sides, respectively, across the glass substrate 3. The lower elastic plate 15 is preferably formed from silicon rubber having an appropriate hardness. The appropriate hardness value is preferably around 70 according to the JIS standard relating to rubber.

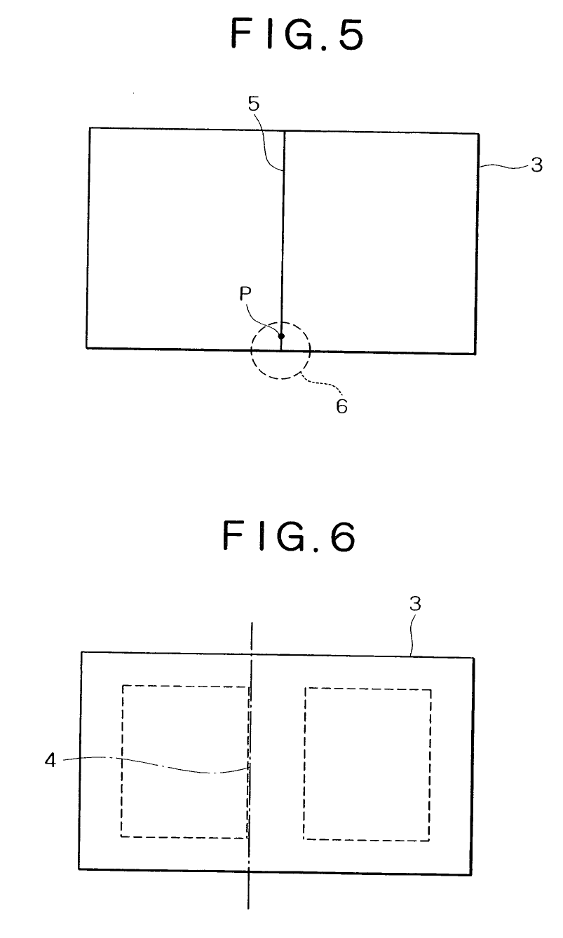

As shown in FIG. 5, the pressurizing mechanism 6 is arranged at a position or positions corresponding to one end site or the opposite end sites (opposite ends) of a cut guiding streak 5. The sharp line 13 of the locally pressing sharp blade 12 positionally corresponds to a point P in the end region of the cut guiding streak 5. The point P may be enlarged to a short line segment. An initial crack is generated in the point region or short line segment region positionally corresponding to the point P in the end region of the programmed cutting line 4 in the glass substrate 3 squeezed between the locally pressing sharp blade 12 and the backing plate 14.

In the cutting process S3 as shown in FIG. 3, a cutting force imparting (bending force imparting) unit 16 is used. The cutting force imparting unit 16 comprises a driven-side cutting force imparting unit 17 and a non-driven-side cutting force imparting unit 18. The driven-side cutting force imparting unit 17 comprises a driving mechanism 19 and a suction unit 21. The driven-side and non-driven-side cutting force imparting units 17 and 18 are arranged on the side of the second surface P2 of the glass sheet 3. The driven-side cutting force imparting unit 17 is arranged on the opposite side of the non-driven-side cutting force imparting unit 18 with respect to the cut guiding streak 5 corresponding with the programmed cutting line 4.

The suction unit 21 comprises a driven-side main body 22 moved toward and away from the surface of the glass sheet 3 by receiving drive force from the drive mechanism 19, and a driven-side suction member 23 supported by the driven-side main body 22 to move substantially integrally with the driven-side main body 22 and adhering by suction to the second surface P2 of the glass sheet 3. The non-driven-side cutting force imparting unit 18 comprises a non-driven-side main body 24 fixed to the glass substrate 3 and a non-driven side suction member 25 supported by the non-driven-side main body 24 to move substantially integrally with the non-driven-side main body 24 and adhering by suction to the second surface P2 of the glass substrate 3. The driven-side cutting force imparting unit 17 is arranged substantially in mirror symmetry with the non-driven-side cutting force imparting unit 18 with respect to the plane including the cut guiding streak 5 and orthogonal to the surface of the glass substrate 3.

Process S1

As shown in FIG. 1, the suction unit 1 operates to adhere by suction to the first surface P1 of the glass substrate 3, and the streak marking unit 2 operates to form a cut guiding streak 5 in the first surface P1 of the glass substrate 3. The streak marking unit 2 is moved along the programmed cutting line 4. The programmed cutting line 4 is, as shown in FIG. 4, formed in the vicinity of one edge of one panel of three panels to be formed from the glass substrate 3. Alternatively, as shown in FIG. 5, the line 4 is formed in the vicinity of one edge of one panel of two panels to be formed from the glass substrate 3.

Process S2:

As shown in FIG. 2, the pressurizing mechanism 6 operates to bring the upper elastic plate 20 in contact with the first surface P1 of the glass sheet 3, and the locally pressing sharp blade 12 presses the glass plate 3 through the upper elastic plate 20, and the sharp line 13 of the locally pressing sharp blade 12 locally applies pressure to the point region or short line segment region of the cut guiding streak 5. The local pressure is dissipated uniformly through the upper elastic plate 20 to the local periphery of the local point or to the local sides of the local short line segment. The pressure generated by the downward movement of the locally pressing sharp blade 12 is attenuated and further dissipated within the lower elastic plate 15.

The locally pressing sharp blade 12 presses the first surface P1 of the glass sheet 3 with an appropriate pressure. The pressure is transmitted to the backing plate 14 via the glass substrate 3, and the glass sheet 3 is squeezed between the sharp line of the locally pressing sharp blade 12 and the surface of the rigid backing plate 14, whereas the lower elastic plate 15 present between the glass sheet 3 and the backing plate 14 effectively prevents excessive stress from being applied to the local site in the glass sheet 3, namely the end region of the cut guiding streak 5. The sharp line 13 of the locally pressing sharp blade 12 matches the end region of the cut guiding streak to cause proper stress to be generated in the glass sheet 3 through the end region. This proper stress enables the glass sheet 3 to be cut along the cut guiding streak 5.

Process S3:

As shown in FIG. 3, the drive mechanism 19 of the driven-side cutting force imparting unit 17 operates to lift the driven-side main body 22 so that one of the left and right sections of the glass sheet 3 divided by the cut guiding streak 5 is thereby pushed up in the direction from the second surface P2 to the first surface P1 under appropriate pressure. The other of the left and right sections of the glass sheet 3 is held by suction by means of the non-driven-side suction member 25 of the non-driven-side cutting force imparting unit 18. Relative rotational movement is generated between the left and right sections around the line including the cut guiding streak 5 and the above-mentioned initial cracks formed in the form of line segments in the end regions of the cut guiding streak 5. This relative rotational movement causes the stress to be concentrated on the initial cracks. The stress thus concentrated causes shear stress to be produced in the initial cracks and the initial cracks are initially cut off in a shearing way. The cutting force is guided to the cut guiding streak 5 by the inductive property due to the crystallinity of glass and transmitted from one end to the other end of the cut guiding streak 5. The glass sheet 3 is cut off by the line corresponding to the programmed cutting line 4.

In the cutting process, the sharp line 13 directly applies pressure to the cut guiding streak 5 inducing the cutting force, while the rear side position corresponding to the site receiving the pressure is supported elastically by the lower elastic plate 15. The pressure applied to the rear side is dissipated all over by the variability of the internal stress possessed by the lower elastic plate 15 itself. One point or one line segment in the lower elastic plate 15 serves as a fulcrum or fulcrum line when the glass sheet left and right sections divided by the programmed cutting line 4 are bent relative to each other, and this fulcrum line also constitutes a symmetry reference line for cutting off the glass sheet 3 into the left and right sections. The glass sheet 3 thus can be cut off with the cut surface formed flat along a straight line. It is preferable that, during the cutting process, either one or both of the driven-side suction member 23 and the non-driven-side suction member 25 is or are displaced to the side of the first surface P1 of the glass sheet 3. The cut guiding streak 5 and the cracks at the ends thereof both initially guide the cutting force as stress in the glass that is an amorphous material.

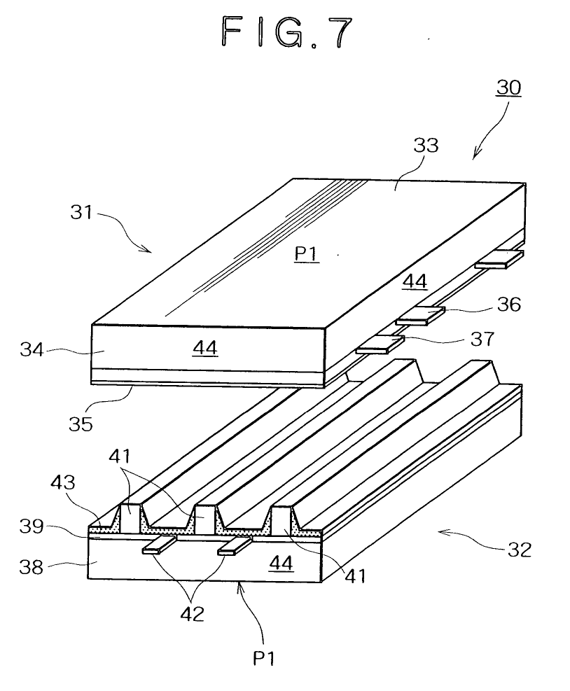

FIG. 7 shows a plasma display panel 30 as an example that is assembled by incorporating a glass substrate produced by the method described above. The plasma display panel 30 comprises a front frame board 31 and a rear frame board 32. The front frame board 31 is formed of a first transparent glass substrate 33 manufactured by the PDP substrate cutting method of the invention, a transparent dielectric layer 34 joined to the rear side of the first transparent glass substrate 33, and a surface protective layer 35 joined to the rear side of the transparent dielectric layer 34. A scanning electrode 36 and a sustaining electrode 37 are arranged between the first transparent glass substrate 33 and the transparent dielectric layer 34. The scanning electrode 36 and the sustaining electrode 37 are disposed parallel with each other. The scanning electrode 36 and the sustaining electrode 37 are respectively constituted by a transparent electrode and a bus electrode. The transparent dielectric layer 34 covers the scanning and sustaining electrodes 36 and 37.

The rear frame board 32 is formed of a second transparent glass substrate 38 manufactured by the PDP substrate cutting method of the invention, a white dielectric layer 39 joined to the front side of the second transparent glass substrate 38, and a plurality of partitions 41 joined to the front side of the white dielectric layer 39. The partitions 41 define display cells. A data electrode 42 is arranged between the second transparent glass substrate 38 and the white dielectric layer 39. The data electrode 42 intersects orthogonally with the scanning electrode 36 and the sustaining electrode 37. The white dielectric layer 39 covers the data electrode 42. A phosphor layer 43 is formed on the side faces of the partitions 41 and on the front surface of the white dielectric layer 39 for converting ultraviolet rays generated by the discharge of discharge gas into visible light. The phosphor layer 43 is color coded with three primary colors of R, G, and B for each cell.

The front frame board 31 and the rear frame board 32 are assembled fixedly with a gap defined therebetween. The width of the gap is designed to be about 100 μm. The side peripheries of the front and rear frame boards 31 and 32 are tightly sealed with a seal material, so that the gap forms a sealed space. The sealed space is filled with helium, neon, xenon, or mixture gas including any of these. The rear frame board 32 is provided with a vent tube (not shown) passing through the second transparent glass substrate 38 and opening into the sealed space. The outside end opening of the vent tube is connected to a gas discharging and filling apparatus (not shown), so that gas such as air or the like is sucked and discharged through the opening, and then the above-mentioned gas is injected into the above-mentioned sealed space. After the injection, the opening is chipped on by heating means so that the open end is closed to hermetically enclose the injected gas within the sealed space.

It is important that the side peripheries 44 of the first and second transparent glass substrates 33 and 38 of the plasma display panel 30, where such hermetical seal is required, are formed as a flat face, not as a curved face, intersecting orthogonally to the first surface P1 described above. In this regard, the side periphery 44 is formed to be an orthogonal plane by the PDP substrate cutting method according to the present invention. The side periphery 44 thus formed is coated with a fusing material.

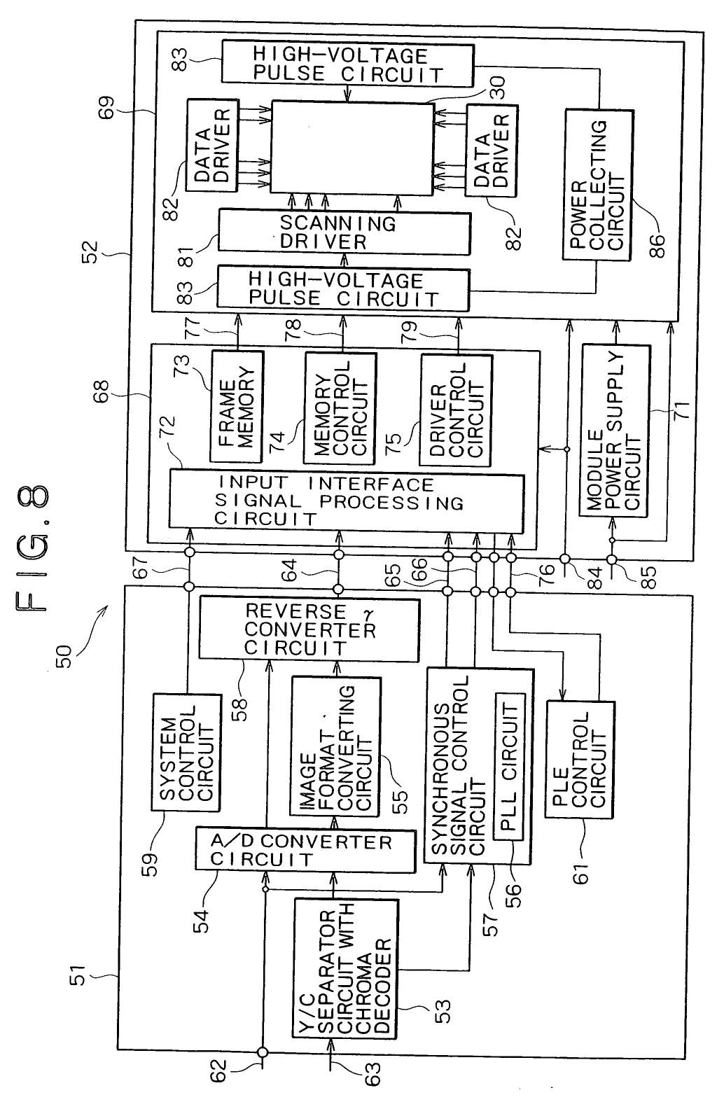

FIG. 8 shows a plasma display device 50 including a plasma display panel 30 assembled as described with reference to FIG. 7. The plasma display device 50 is modularized. The modularized plasma display device 50 comprises an analog interface 51, and a plasma display panel module 52.

The analog interface 51 comprises a Y/C separator circuit 53 having a chroma decoder, an A/D converter circuit 54, an image format converting circuit 55, a synchronous signal control circuit 57 having a PLL circuit 56, a reverse y converter circuit 58, a system control circuit 59, and a PLE control circuit 61. The analog interface 51 converts a received analog video signal (an analog RGB signal 62 and an analog video signal 63) into a digital video signal 64 and outputs this digital video signal 64 to the plasma display panel module 52. More specifically, an analog video signal 63 transmitted by a TV tuner is decomposed into luminance signals of colors R, G, and B by the Y/C separator circuit 53, and then converted into a digital video signal 64 by the A/D converter circuit 54. If the pixel constitution of the plasma display panel module 52 is different from that of the analog video signal 63, the digital video signal 64 is converted into an appropriate image format by the image format converting circuit 55.

The analog video signal 63 does not include a sampling clock or data clock signal for A/D conversion. The PLL circuit 56 included in the synchronous signal control circuit 57 generates a sampling clock 65 and a data clock signal 66 with reference to a horizontal synchronizing signal supplied thereto at the same time with the analog video signal 63. The sampling clock 65 and the data clock signal 66 are outputted from the analog interface 51 and received by the plasma display panel module 52. The PLE control circuit 61 increases the display luminance if the average luminance level is not more than a predetermined value, and decrease the display luminance if the average luminance level is not less than the predetermined value. The system control circuit 59 generates various types of control signal 67. The control signal 67 is outputted by the analog interface 51 and received by the plasma display panel module 52.

The plasma display panel module 52 comprises a digital signal processing/controlling circuit 68, a panel part 69, and a module power source circuit 71 having a built-in DC/DC converter. The panel part 69 includes the plasma display panel 30 described above. The digital signal processing/controlling circuit 68 comprises an input interface signal processing circuit 72, a frame memory 73, a memory control circuit 74, and a driver control circuit 75. The average luminance level of the digital video signal 64 inputted to the input interface signal processing circuit 72 from the analog interface 51 is calculated by an input signal average luminance level calculating circuit (now shown) provided in the input interface signal processing circuit 72 and outputted as data of an appropriate number of bits (e.g. 5 bits). PLE control data 76 set by the analog interface 51 in correspondence with the average luminance level is inputted to a luminance level control circuit (not shown) in the input interface signal processing circuit 72.

The digital signal processing/controlling circuit 68 processes the above-mentioned signal in the input interface signal processing circuit 72 and transmits the processed control signal 77 to the panel part 69. At the same time as the transmission of the processed control signal 77, the memory control circuit 74 and the driver control circuit 75 generate a memory control signal 78 and a driver control signal 79, respectively, and transmit these signals to the panel part 69.

The panel part 69 comprises the plasma display panel 30, a scanning driver 81 (mounted integrally in the panel part 69) for driving the scanning electrode 36 (see FIG. 7), and a data driver 82 (mounted integrally in the panel part 69) for driving the data electrode 42 (see FIG. 7). The panel part 69 further comprises a high-voltage pulse circuit 83 for supplying pulsed voltage to the plasma display panel 30, scanning driver 81, and data driver 82. The high-voltage pulse circuit 83 is arranged and packaged at a plurality of positions of the panel part 69 as a part of the panel part 69.

The plasma display panel 30 has 1365×768 pixels arrayed in 1365×768 grid. In the plasma display panel 30, the scanning driver 81 controls the scanning electrode 36 and the data driver 82 controls the data electrode 42, so that control is performed to turn on or not to turn on a predetermined number of pixels from among the above-mentioned number of pixels, and prescribed display is thereby performed.

A logic power supply (not shown) supplies logic power to the digital signal processing/controlling circuit 68 and the panel part 69 through a power input terminal 84. The module power source circuit 71 is supplied with DC power from a display power supply (not shown) through another power input terminal 85 and supplies the DC power to the panel part 69 after changing the voltage thereof to a predetermined voltage.

The plasma display panel 30, the scanning driver 81, the data driver 82, and the high-voltage pulse circuit 83 are arranged and packaged, together with a power collecting circuit 86, on a single substrate constituting the main body of the panel part 69. In the panel part 69, the main body, the plasma display panel 30, the scanning driver 81, the data driver 82, the high-voltage pulse circuit 83, and the power collecting circuit 86 are constructed integrally. The digital signal processing/controlling circuit 68 is separated from the panel part 69 and formed mechanically independently from the panel part 69.

The module power source circuit 71 is separated from the digital signal processing/controlling circuit 68 and the panel part 69 and formed mechanically independently therefrom. The digital signal processing/controlling circuit 68, the panel part 69, and the module power source circuit 71 are assembled as a single module. The plasma display panel module 52 constitutes the single module thus assembled. The analog interface 51 is separated from the plasma display panel module 52 and is formed mechanically independently therefrom. The plasma display panel module 52 is electrically connected to the analog interface 51 by electric wiring for transmitting the control signal 67, the digital video signal 64, the sampling clock 65, the data clock signal 66, the PLE control data 76, and other signals.

The analog interface 51 and the plasma display panel module 52 are, after being formed separately, incorporated and fixedly supported in the housing of the plasma display device to build up the plasma display device 50. In the plasma display device 50 modularized in this manner, the analog interface 51 and the plasma display panel module 52 can be manufactured separately from other equipment components. Therefore, if the plasma display device 50 breaks down, the plasma display device 50 with failure can be replaced with a new plasma display device 50 while leaving the plasma display panel module 52 as it is, so that the repair of the plasma display device 50 can be simplified and the time required for the repair can be shortened.

With the method and the apparatus for cutting a PDP substrate and the method for manufacturing a PDP device according to the present invention, it is possible to produce a glass substrate having a cut surface that is highly vertical to the substrate surface and hence to ensure good quality for the PDP devices produced using the glass substrate.

What is claimed is:

1. A method for cutting a glass sheet, comprising the steps of:
forming a linear groove in a glass sheet along a programmed cutting line that is set for the glass sheet; and
applying local pressure to an end of the groove.

2. The method for cutting a glass sheet according to claim 1, wherein
said applying of local pressure is a step of making a crack along the groove.

3. A method for cutting a glass sheet, comprising the steps of:
forming a linear groove in a glass sheet along a programmed cutting line that is set for the glass sheet; and
arranging an elastic plate at an end of the groove for dissipating pressure and arranging a pressure absorber on the rear surface of the glass sheet opposing the end of the cutting line.

4. The method for cutting a glass sheet according to claim 1, further comprising the step of lifting one of two sections of the glass sheet divided by the groove with respect to the other one to from a V-shape section together, by using the groove as the fulcrum.

5. The method for cutting a glass sheet according to claim 3, further comprising the step of lifting one of two sections of the glass sheet divided by the groove with respect to the other one to from a V-shape section together, by using the groove as the fulcrum.

6. The method for cutting a glass sheet according to claim 1, wherein
the glass sheet is used as a front substrate or a rear substrate of a plasma display panel.

7. The method for cutting a glass sheet according to claim 3, wherein
the glass sheet is used as a front substrate or a rear substrate of a plasma display panel.

8. A method for manufacturing a PDP device, comprising the steps of:
producing a plasma display panel;
incorporating the plasma display panel into a module together with a circuit for driving the plasma display panel; and
electrically connecting an interface to the module, the interface for transmitting an image signal after converting the format thereof to the module, wherein
in the first step, the method for producing the plasma display panel according to claim 5 is performed.

9. An apparatus for cutting a glass sheet comprising:
an elastic plate arranged at an end of a programmed cutting line of a glass sheet, for dissipating pressure;
a pressure absorber arranged on the rear surface of the glass sheet opposing the end of the cutting line; and
a pressurizing mechanism for applying pressure to the elastic plate.

10. The apparatus for cutting a glass sheet according to claim 9, wherein
the pressurizing mechanism makes a crack along and over the programmed cutting line.

11. The apparatus for cutting a glass sheet according to claim 9, further comprising a driving mechanism for lifting one of two sections of the glass sheet to be separated from each other by the programmed cutting line, with respect to the other one so as to form a V-shape section.

12. The apparatus for cutting a glass sheet according to claim 9, wherein
the pressurizing mechanism further comprising a pressurizing needle for transferring pressure to the glass sheet.

13. The apparatus for cutting a glass sheet according to claim 12, wherein
a tip end of the pressurizing needle is pointed to the programmed cutting line and is formed sharp.

14. The apparatus for cutting a glass sheet according to claim 13, wherein
the tip end is formed sharp to take a form of a point.

15. The apparatus for cutting a glass sheet according to claim 13, wherein
the tip end is formed sharp to take a form of a line.

16. The apparatus for cutting a glass sheet according to claim 13, wherein
the tip end is formed sharp to take a form of a semispherical surface, or a semicylindrical surface.

17. An apparatus for cutting a PDP substrate, having a pressurizing mechanism for applying cutting induction force to a programmed cutting line set for a glass sheet,
the pressurizing mechanism comprising:
an applying member mounted on the side of a first surface of the glass sheet for applying cutting induction force to the glass sheet from the side of the first surface; and
a support arranged on the side of a second surface of the glass sheet in opposition to the applying member for elastically supporting the glass sheet from the side of the second surface.

18. The apparatus for cutting a PDP substrate according to claim 17, wherein
the support is formed of an elastic displacement member directly joined to the second surface and a rigid body supporting the elastic displacement member.

19. The apparatus for cutting a PDP substrate according to claim 18, wherein
the elastic displacement member is formed from silicon rubber.

20. The apparatus for cutting a PDP substrate according to claim 17, wherein
a tip end of the applying member is formed sharp to take a form of a point, a line, a semispherical surface, or a semicylindrical surface.

21. The apparatus for cutting a PDP substrate according to claim 17, wherein
the pressurizing mechanism is formed by:
a first suction member attached to the second surface side of one of the sections of the glass sheet to be divided by the programmed cutting line so as to adhere by suction to the second surface;
a second suction member attached to the second surface side of the other section of the glass sheet to be divided by the programmed cutting line so as to adhere by suction to the second surface; and
a driver for displacing the second suction member to the direction of the first surface with respect to the first suction member.

22. The apparatus for cutting a PDP substrate according to claim 21, further comprising a streak marking unit for marking a streak along the programmed cutting line, wherein
the applying member makes a crack at an end of the streak, and the first and the second suction members cut the glass sheet.
